(19) United States
(12) Patent Application Publication
(10) Pub. No.: US 2023/0109567 A1
(43) Pub. Date: Apr. 6, 2023

(54) PREDICTIVE MAINTENANCE OF A RECEPTACLE HANDLING INSTALLATION

(71) Applicant: KRONES AG, Neutraubling (DE)

(72) Inventors: Philipp OLENBERG, Neutraubling (DE); Christian MEYKNECHT, Neutraubling (DE)

(21) Appl. No.: 18/060,487

(22) Filed: Nov. 30, 2022

(30) Foreign Application Priority Data
Dec. 1, 2021 (DE) 10 2021 132 684.7

(51) Int. Cl. B67C 3/00; B67C 3/24; B67C 3/28

(52) U.S. Cl. CPC B67C 3/007; B67C 3/24; B67C 3/28

(57) ABSTRACT

An apparatus, system and method for predictively maintaining a receptacle handling installation, for example a beverage bottling installation, wherein the apparatus is configured to receive process data of at least one handling operation on one or more receptacles, performed by the receptacle handling installation; assign the handling operation to at least one of multiple quality classes on the basis of the process data; and derive a state of wear for one or more components of the receptacle handling installation from an analysis of the quality classes.

### CROSS-REFERENCE TO RELATED APPLICATIONS

This application claims priority from German Patent Application No. DE 10 2021 131 684.7, filed on Dec. 1, 2021 in the German Patent and Trademark Office, the disclosure of which is incorporated herein by reference in its entirety.

### BACKGROUND

### Technical Field

The present invention relates to an apparatus, a system and a method for predictively maintaining a receptacle handling installation, for example a beverage bottling installation.

### Related Art

In the beverage bottling industry, comprising installations and processes for bottling, manufacturing, capping, labeling receptacles and the like, complex controls that make settings for the industrial installations automatically or semiautomatically are increasingly being used. As such, EP 3 495 911 A1 and WO 2019/048051 A1 describe methods for automatically adapting process parameters of a bottling installation. EP 3 187 948 B1 describes a system and method for managing product quality in receptacle processing installations.

For this purpose, sensor data and other process data are recorded during operation of the installation and, if necessary, processed in real time in order to control/regulate the installation. As such, for example a filling valve control of a filling apparatus records one dataset per filling operation.

These process data may be used not only for control/regulation but also for troubleshooting in situ, this requiring a high level of manual analysis effort. A disadvantage of this is that the operator of the installation, for example a customer of a bottling installation, is required to have expert knowledge about technical details of the installation used. The operator must be able to react to any faults. Reactive maintenance such as this leads to unplanned stoppages for the installation. Systematic, preventive maintenance may involve flawless or still usable components being replaced, resulting in increased resource expenditure and unnecessary costs.

### SUMMARY

The maintenance of a receptacle handling installation, for example a beverage bottling installation, in particular to allow or lend support to predictive maintenance, is described herein according to various embodiments.

The present invention relates to predictive maintenance of a receptacle handling installation, for example comprising an installation for filling receptacles and/or capping filled receptacles and/or manufacturing, in particular blow moulding, receptacles. The invention is in some embodiments used in installations for bottling beverages, for example water (still or carbonated), soft drinks, juices, smoothies, beer, wine, milk products, mixed beverages and the like.

The predictive maintenance apparatus (also referred to herein as the “maintenance support apparatus”) is configured to receive process data of at least one handling operation on one or more receptacles by the receptacle handling installation, to assign the handling operation to at least one of multiple quality classes on the basis of the process data, and to derive a state of wear for one or more components of the receptacle handling installation from an analysis of the quality classes.

For this purpose, the maintenance support apparatus is in communication with an installation control of the receptacle handling installation and/or with subordinate controls of one or more handling stations, for example with a filler control. The process parameters, or process data, which are already recorded therein, comprising sensor data, may easily be made available to the maintenance support apparatus for further processing.

The maintenance support apparatus comprises an electronic computing device; it may be implemented centrally or in decentralized fashion, as a component part of Internet-based and/or cloud-based applications or in another way, and, if necessary, may access databases. The communication with the receptacle handling installation may take place wirelessly or by wire, digitally or in analogue fashion.

The maintenance support apparatus lends support to predictive, flexible and individual maintenance of the receptacle handling installation by classifying handling operations and deriving therefrom states of wear for components of the receptacle handling installation. The quality classes in this instance define a measure of the quality of the handling. They may be predefined or created manually or automatically during setup of the database. In other words, process data and the handling quality achieved with the process data are correlated with one another, in certain embodiments over a multiplicity of handling operations. The “knowledge” thus accumulated may be used to predict states of wear and to derive action recommendations.

An associated occurrence is simplification of spare parts procurement, for example by way of integration into an e-shop by linking to an existing customer account and/or automatic processing, in various embodiments by applying so-called “smart contracts” and crypto currencies.

The described classification of the recorded handling processes may be extended to include new data at any time. The more fault classes there are in the analysis by the maintenance support apparatus, the more granular the way in which the classification is performed may be and the more accurately the modeling for determining states of wear and any prediction of defects, downtimes, etc., may take place.

In one or more embodiments, one of the quality classes characterizes good handling operations, while another of the quality classes characterizes poor handling operations. There may be provision for further quality classes, or in the simplest case the classification distinguishes only between a good handling operation and a poor (erroneous, inadequate, etc.) handling operation (=binary classification). The maintenance support apparatus therefore creates a classified database, on the basis of which it is then possible to derive action recommendations during future handling operations. By way of example, a measure of the state of wear of each individual filling element of a filler carousel may be derived and reported back to the receptacle handling installation, an operator, a manufacturer of the receptacle handling installation, a maintenance centre, spare parts store or the like.

In several embodiments, the maintenance support apparatus is further configured to perform an analysis of past handling operations for at least one handling operation from the quality class of the poor handling instances and to derive a further quality class, which characterizes limit-value handling operations, from the process data of said past handling operations. If such a borderline case is detected in the future, predictive measures may be performed on the receptacle handling apparatus even before a fault occurs.

In certain embodiments, the maintenance support apparatus is configured to receive process data from handling operations of one or more further receptacle handling installations and to assign the handling operations of the further receptacle handling installations to the quality classes on the basis of the applicable process data and/or to create quality classes therefrom. The further receptacle handling installations may be designed in an equivalent manner to the present receptacle handling installation or differently therefrom, but at least in some cases in a technically comparable manner. The further receptacle handling installations may be used to determine and evaluate process data that go beyond the local information of a single receptacle handling installation. By using information from multiple receptacle handling installations, the predictive maintenance of the receptacle handling installation(s) may be improved by virtue of each individual installation benefiting from information from other comparable installations.

In some embodiments, the maintenance support apparatus is configured to report back the determined state of wear for one or more components of the receptacle handling installation or an action recommendation derived therefrom to a device, for example the receptacle handling installation. This allows predictive measures to be performed on the receptacle handling apparatus manually or automatically even before a fault occurs.

In various embodiments, the maintenance support apparatus comprises an Internet/cloud application and/or data processing, the data processing in one embodiment providing a central or decentralized database and/or a server and/or an AI application. The integration of an Internet/cloud application allows the processes associated with predictive maintenance to be implemented as digital services.

In some embodiments, the handling operation is a filling operation involving a filling apparatus of the receptacle handling installation putting a filling product into one or more receptacles, the process data received by the maintenance support apparatus in this case for example comprising data of one or more of the following process parameters: bottling pressure, pressurization time, pressurization pressure, evacuation pressure, fill rate, fill curve, depressurization time. Predictive maintenance is particularly useful for technically complex filling apparatuses in order to keep the stoppage times of the installation as short as possible.

A system comprising a maintenance support apparatus according to one of the variant embodiments described above and a receptacle handling installation in communication therewith is also described herein according to various embodiments.

The technical effects, advantages and embodiments described in relation to the maintenance support apparatus apply to the system in an analogous manner.

In several embodiments, the receptacle handling installation is a beverage bottling installation having an apparatus for filling receptacles with a filling product. The apparatus for filling receptacles in one embodiment has a filler control configured to control a filling operation of the apparatus for filling receptacles, the filler control being in communication with the maintenance support apparatus directly or via an installation control, i.e. a higher-order control, and being configured to send process data of the filling operation to the maintenance support apparatus.

In one or more embodiments, the apparatus for filling receptacles comprises a filler carousel and multiple filling elements installed on the outer circumference thereof that are configured to introduce the filling product into applicable receptacles, the maintenance support apparatus being configured to derive a state of wear for one or more of the filling elements. As such, illustrative data processing for predictive maintenance may comprise: data transmission of one or more bottling rounds of all filling elements to the Internet/cloud application of the maintenance support apparatus; classification of a time series of a filling operation by the data processing, for example using statistical methods, neural networks or the like.

A method for predictively maintaining a receptacle handling installation, for example a beverage bottling installation is further described herein according to certain embodiments, the method comprising: receiving process data of at least one handling operation on one or more receptacles, performed by the receptacle handling installation; assigning the handling operation to at least one of multiple quality classes on the basis of the process data, and deriving a state of wear for one or more components of the receptacle handling installation from an analysis of the quality classes.

The technical effects, advantages and embodiments described in relation to the maintenance support apparatus and the system apply to the method in an analogous manner.

As such, for the reasons cited above, one of the quality classes in certain embodiments characterizes good handling operations, while another of the quality classes characterizes poor handling operations.

In one or more embodiments, for the reasons cited above, an analysis of past handling operations is performed for at least one handling operation from the quality class of the poor handling instances, a further quality class, which characterizes limit-value handling operations, being derived from the process data of said past handling operations.

In several embodiments, for the reasons cited above, process data are received from handling operations of one or more further receptacle handling installations, the handling operations of the further receptacle handling installations being assigned to the quality classes on the basis of the applicable process data and/or quality classes being created therefrom.

In some embodiments, for the reasons cited above, the handling operation is a filling operation of putting a filling product into at least one receptacle, the received process data for example comprising data of one or more of the following process parameters: bottling pressure, pressurization time, pressurization pressure, evacuation pressure, fill rate, fill curve, depressurization time.

Further advantages and features of the present invention are clear from the description of exemplary embodiments that follows. The features described therein can be implemented alone or in combination with one or more of the features presented above, provided that the features are not inconsistent with one another. Exemplary embodiments are described below in this case with reference to the accompanying drawings.

### BRIEF DESCRIPTION OF THE FIGURES

Further embodiments of the invention are explained in more detail by way of the description of the figures that follows.

FIG. 1 shows a schematic representation of a beverage bottling installation according to an exemplary embodiment, comprising an apparatus for filling receptacles with a filling product;

FIG. 2 shows a schematic representation of the apparatus for filling receptacles with a filling product according to an exemplary embodiment; and

FIG. 3 shows a schematic representation of an apparatus for predictively maintaining a receptacle handling installation.

### DETAILED DESCRIPTION

Exemplary embodiments are described below with reference to the figures. Here, elements that are identical, similar or have the same effect are provided with identical reference signs in the figures and a repeated description of these elements is omitted in some cases in order to avoid redundancy.

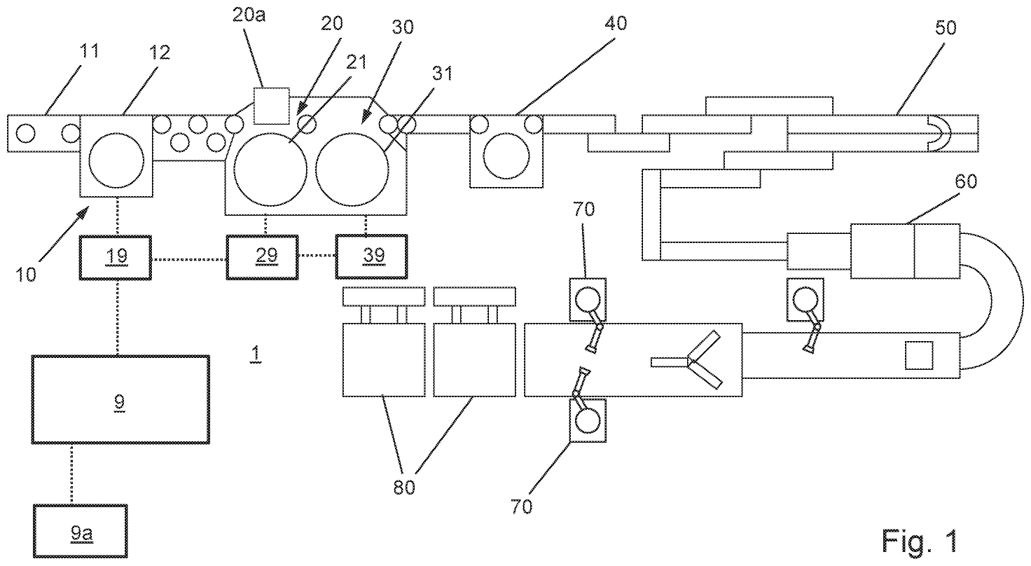

FIG. 1 shows a receptacle handling installation 1 comprising multiple receptacle handling stations. The receptacle handling installation 1 in the present exemplary embodiment is a beverage bottling installation, since at least one of the receptacle handling stations is an apparatus 20 for filling the receptacles (not shown in FIG. 1) with a filling product, in particular a beverage.

According to the present exemplary embodiment, the receptacle handling installation 1 comprises the following receptacle handling stations: an apparatus 10 for manufacturing receptacles, also referred to herein as the “receptacle manufacturing apparatus”; an apparatus 20 for filling the receptacles with a filling product, also referred to herein as the “filling apparatus”; an apparatus 30 for capping the receptacles with one receptacle cap each, for example a crown cork or screw cap, also referred to herein as the “capping apparatus”; an apparatus 40 for labeling the receptacles, also referred to herein as the “labeler”; a buffer 50 for temporarily buffering filled and labeled receptacles and for evening out any different processing/transport speeds between installation parts; a packing apparatus 60 for packing the receptacles; robots 70 for layer production; and a palletizer 80 that combines the packed receptacles onto load carriers.

The receptacle handling installation 1 accordingly comprises one or more receptacle handling stations that are passed through progressively for example from manufacture of the receptacles through filling thereof, capping, labeling, to packing of same. For this purpose, the receptacles, or the preforms thereof, which are precursors to the receptacles before blow moulding or stretch blow moulding, are transported along a conveyor path. Transport is effected by means of transport stars, transport belts and the like, some of which are schematically represented in FIG. 1. Preforms, receptacles, receptacle caps and brackets/clamps configured therefor are not represented in FIG. 1 for the sake of clarity. Transport devices such as transport stars or transport belts may be used solely for conveying or may be equipped with handling elements in accordance with the handling stations.

The receptacle handling stations of the receptacle handling installation 1 that are shown in FIG. 1 are merely illustrative. As such, the receptacle handling installation 1 may be equipped with further or alternative receptacle handling stations, such as for example a cleaning apparatus, a test apparatus for assuring quality, for example for testing whether foreign particles have got into the filled receptacle, and the like. Stations may likewise be dispensed with, such as for example the receptacle manufacturing apparatus 10 if the receptacles are already supplied in the final form to be filled, the buffer 50, the packing apparatus 60 and/or others.

The receptacle manufacturing apparatus 10 has a device 11 for preparing and preheating preforms made from plastic, for example polyethylene terephthalate (PET). The preforms thus prepared are transferred to a blowing device 12, in which the heated preforms are expanded by blowing or stretch blowing to produce the receptacles to be filled. For this purpose, the preforms are subjected to a gas under pressure in blowing moulds, the cavity contour of which corresponds to the intended receptacle outer shape, and are also expanded with a stretching rod during stretch blowing, in order to take the preforms into the desired receptacle shape. The receptacle manufacturing apparatus 10 may comprise an apparatus for cleaning, sterilizing and/or coating the receptacles that is not shown in more detail.

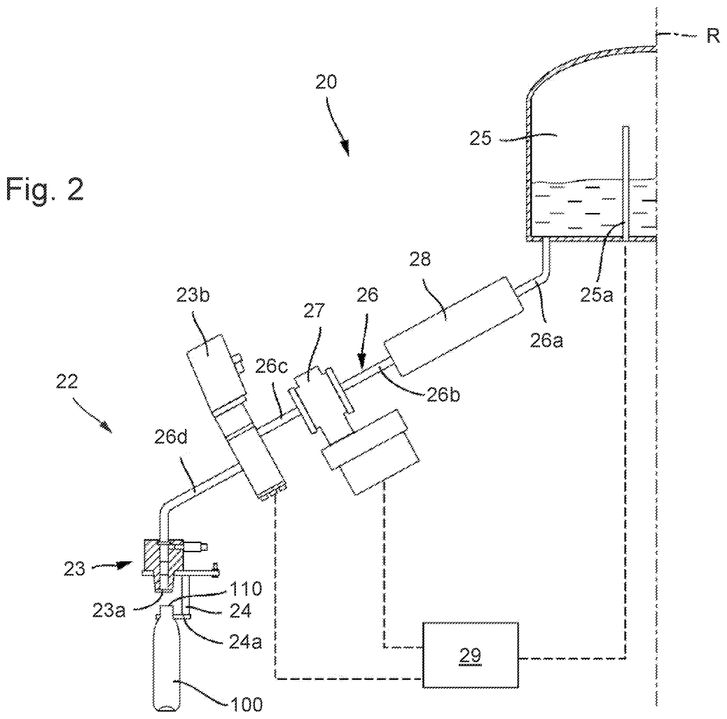

The receptacles thus manufactured are transferred to the filling apparatus 20. In the exemplary embodiments in FIGS. 1 and 2, the filling apparatus 20 is based on a rotary-machine design. For this purpose, it comprises a filler carousel 21, on the outer circumference of which there is provision for a multiplicity of filling elements (not represented in FIG. 1) configured for introducing the filling product into the receptacles. The filling apparatus 20 may comprise a mixer 20a configured to manufacture a filling product consisting of multiple components, for example by mixing syrup into a drinking water stream.

After filling, the receptacles are transferred to the capping apparatus 30, which may likewise be embodied in a rotary-machine design. For this, the capping apparatus 30 comprises a capper carousel 31, on the outer circumference of which there is provision for a multiplicity of capping elements (not represented in FIG. 1) configured for capping the filled receptacles with one receptacle cap each.

The filled receptacles may be transferred from the filling apparatus 20 to the capping apparatus 30 directly from the filler carousel 21 to the capper carousel 31 or using one or more transfer stars. Alternatively, the filling apparatus 20 and the capping apparatus 30 may be integrated to form a filler/capper wherein the processing processes of filling and capping take place at different handling angles of one and the same handling carousel.

FIG. 2 schematically shows an illustrative apparatus 20 for filling receptacles 100 with a filling product.

In the exemplary embodiment shown in FIG. 2, the filling apparatus 20 comprises a filling valve 33 that introduces a filling product into the receptacle 100 via a valve mouth 23a. Possible filling products are in one embodiment beverages, for example water (still or carbonated), soft drinks, juices, smoothies, beer, wine, milk products, mixed beverages and the like.

During the filling process, the mouth 110 of the receptacle 100 is in various embodiments in pressure-tight contact with the filling valve 23, which allows the filling process to be performed as a back-pressure method or reduced-pressure method. However, the filling valve 2 may also be in the form of a free-jet valve, as a result of which the filling product is put into the mouth 110 of the receptacle 100 after passing across a free-jet region. Furthermore, the filling process and, if necessary, subsequent capping of the receptacle 100 may take place in a pressure- and vacuum-tight handling chamber (not shown in the figures) that allows a defined atmosphere having a defined pressure to be provided, for example in order to counteract any tendency of the filling product to froth over or to cap the receptacle 100 in a defined gas atmosphere and/or under vacuum or overpressure.

The receptacle 100 to be filled is held on or beneath the filling valve 23 by way of a receptacle bracket 24 during filling. The receptacle bracket 24 in one embodiment has a retaining clamp 24a for holding the receptacle 100 to be filled in the neck region, for example beneath a neck ring of the receptacle 100 that is not shown here. This is also referred to as so-called “neck handling” of the receptacle 100. “Neck handling” is used in particular when filling plastic receptacles in the form of PET bottles. In an alternative that is not shown in the figures, the receptacle 100 to be filled may also be held, or supported, in its base region, for example by a guide plate on which the receptacle 100 to be filled is standing. This is also referred to as so-called “base handling” of the receptacle 100. “Base handling” is used in particular when filling glass bottles. In an alternative that is likewise not shown in the figures, the receptacle 100 to be filled may also be held and/or supported and transported in the region of the receptacle or bottle belly or in another suitable manner.

The filling valve 23 is may be in the form of a proportional valve 23b, or comprises such, arranged before the valve mouth 23a, i.e. upstream of the valve mouth 23a. Optionally, there may be provision for a stop valve in the region of the valve mouth 23a, said stop valve opening/closing the valve mouth 23a as required. The proportional valve 23b is configured to vary the volume flow of the filling product, thereby regulating the amount of filling product introduced into the receptacle 100 per unit time. The aim is to ensure efficient, exact and product-friendly filling along a defined fill curve, which is generally a time-dependent function of the fill rate or of the volume flow.

By way of example, the proportional valve 23b may be designed such that an annular gap through which the filling product flows is of variable dimension. The switching position of the proportional valve 23b, that is to say for example the currently selected dimension of the annular gap, is known and reproducibly adjustable, for example by using a stepper motor to drive the proportional valve 23b.

The proportional valve 23b may be used to stipulate one or more properties of the fill curve, such as for example the end of filling when a desired fill level is reached or the fill curve in its entirety.

The filling product is temporarily stored in a filling product reservoir 25 before actually being put into the receptacles 100 to be filled, the filling product reservoir 25 being shown here in the form of a central tank of a rotary-machine filler. In an alternative embodiment, the filling product reservoir 25 may also be in the form of an annular tank, an annular line or a distribution supply.

The filling product has been put into the filling product reservoir 25 up to a specific fill level and may flow therefrom via a filling product line 26, which has a first line section 26a, a second line section 26b, a third line section 26c and a fourth line section 26d here by way of illustration, to the filling valve 23, wherefrom it may be introduced into the receptacle 100 to be filled.

Besides the proportional valve 23b for controlling or regulating the filling product flow, there is furthermore provision for a flowmeter 27 configured to detect the amount of fluid, or the volume flow, of the filling product flowing through the filling product line 26. The flowmeter 27 may, if necessary, also be used to determine the amount of filling product introduced into the receptacle 100, for example by integrating, or summing, the determined volume flow. In this manner, after a desired filling product level is reached in the receptacle 100, the filling operation may be terminated by closing the proportional valve 23b and/or by closing a stop valve that is not shown here. As an alternative to the flowmeter 27, it is also possible to use other sensors, such as for example weighing cells and/or short-circuit probes. Alternatively, a sensor may be dispensed with if a time filling process is used that is based on for example computation models for determining the volume flow.

The filling valve 23, including the proportional valve 23b, the flowmeter 27 and sections of the filling product line 26, for example the line sections 26b, 26c and 26d, may form an imaginary and/or physical unit, or component, referred to herein as a filling element 22.

The filling apparatus 20 shown in FIG. 2 shows only one filling element 22, which is fluidically connected to the filling product reservoir 25. However, the filling apparatus 20 in several embodiments has a multiplicity of filling elements 22 that for example are arranged around the then common filling product reservoir 25 and on the outer circumference of the filler carousel 21 (cf. FIG. 1), so as in this way to form a filler of rotary-machine design. The filler carousel 21 rotates about a schematically shown axis of rotation R in order to fill the receptacles 100 during the rotation and at the same time to transport them along a circular trajectory. By way of example, more than 20 or 50 filling elements 22 may be arranged on the circumference of the filler carousel 21, with the result that efficient filling of a stream of receptacles 100 to be filled that is supplied to the rotary-machine filler may be performed.

The filling apparatus 20 may—as a component part of or outside the filling element 22—have one or more filters 28, arranged in one embodiment between the first section 26a and the second section 26b of the filling product line 26. The filter 28 is configured to clean the filling product prior to bottling, for example in order to filter out particles, viruses, bacteria, germs, fungi, etc., from the filling product.

The current fill level of the filling product in the filling product reservoir 25 may be measured by means of a fill-level probe (not shown in the figures), for example.

The filling apparatus 20 further has a filler control 29 configured to communicate with the filling element 22. In particular, the filler control 29 is in communication with the proportional valve 23b, the fill-level probe and the flowmeter 27 in order to stipulate the current switching position of the proportional valve 23b by using the volume flow values determined by the flowmeter 27. Furthermore, the fill level in the filling product reservoir 25 may be evaluated by means of the filler control 29. The fill-level probe and the flowmeter 27 are illustrative sensors for monitoring the filling process.

Returning to FIG. 1, the other receptacle handling stations may also be equipped with appropriate control devices; by way of illustration, a receptacle manufacture control 19 and a capper control 39 are shown. The individual control devices 19, 29, 39 may be implemented centrally or in decentralized fashion, as a component part of Internet-based and/or cloud-based applications or in another way, and, if necessary, may access databases. The communication of the control devices 19, 29, 39 among one another and/or with a superordinate installation control 9 and/or with the components to be actuated, sensors to be read, etc. may take place wirelessly or by wire, digitally or in analogue fashion. Furthermore, the control devices 9, 19, 29, 39 do not need to be implemented by separate devices, but rather may be partially or fully integrated.

The installation control 9 may be realized as an LMS (line management system) that monitors and/or controls the various stations of the receptacle handling installation 1, for example by way of communication with the subordinate, station-specific control devices 19, 29, 39.

The filler control 29 (if necessary in cooperation with the installation control 9) is configured to actuate the filling element 22 of the filling apparatus 20 in such a way that the filling product is introduced into the receptacle 100 in the desired amount and at the desired rate. For this purpose, the filler control 29 or installation control 9 may store one or more sets of process parameters that predefine the process behaviour of the filling apparatus 20, for example pressures, depressurization times and the like. These parameter sets are usually preset and may be associated with different filling product brands to be bottled, for example.

In the simplest case, the filling product is introduced into the receptacle 100 at a constant flow rate, or a constant volume flow. The flow rate, or the volume flow, during filling may have a more detailed functional dependency, however, for example as a function of time, of a fill pressure and/or of other variables.

The specific form of the fill curve may be dependent on the filling product to be bottled, receptacle format (size, geometry, material, etc.), the filler performance and other variables. Startup of the receptacle handling installation 1, a change of brand, change of receptacle format or the like is effected for example by virtue of an operator selecting a previously applied configuration in the menu of an HMI module 9a (“human-machine interface module”), cf. FIG. 1. The HMI module 9a may be part of the installation control 9 or may communicate with the latter. The HMI module 9a may also alternatively or additionally communicate with one or more of the subordinate control devices 19, 29, 39. The HMI module 9a may be a mobile communication device, for example a tablet or smartphone.

The selected configuration is used to store process parameters (bottling pressure, pressurization time, fill curve, etc.) as a dataset in the installation control 9 and/or the control devices 10, 29, 39, these being used to actuate the receptacle handling installation 1. Furthermore, the installation control 9 and/or the control devices 10, 29, 39 record process data that are obtained during operation of the receptacle handling installation 1, determined for example by appropriate sensors.

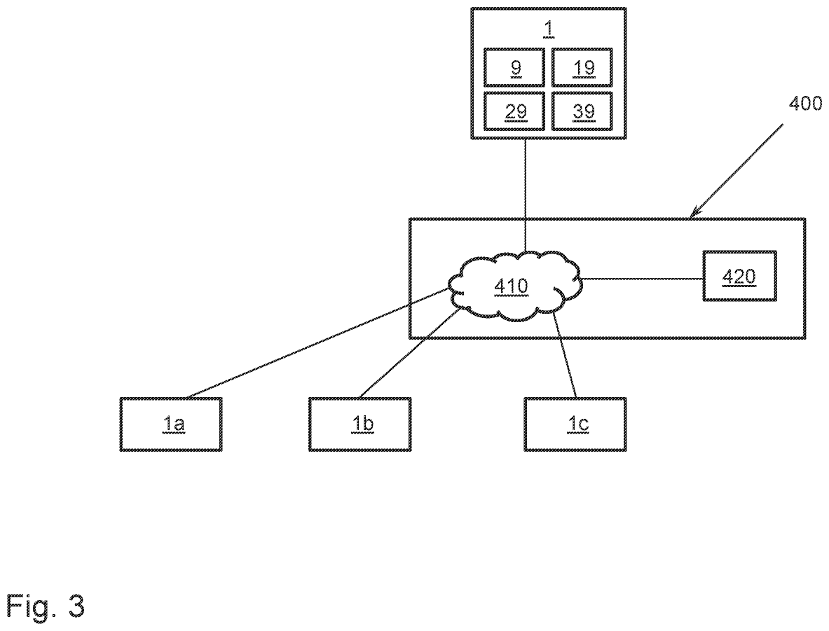

FIG. 3 schematically shows an apparatus 400 for predictively maintaining (also referred to herein as the “maintenance support apparatus”) a receptacle handling installation 1, such as for example the beverage bottling installation in FIG. 1.

The maintenance support apparatus 400 is in communication with the receptacle handling installation 1, in particular one or more of the controls 9, 19, 29, 39. In addition, the maintenance support apparatus 400 may be in communication with further receptacle handling installations 1a, 1b, 1c, or the controls thereof, in order to receive and process process data from the receptacle handling installations 1, 1a, 1b, 1c. The further receptacle handling installations 1a, 1b, 1c may be designed in an equivalent manner to the exemplary embodiments presented above or differently therefrom, but at least in some cases in a technically comparable manner.

In other words, the maintenance support apparatus 400 may be used to collect process data from one or more, in one embodiment hundreds of, receptacle handling installations 1, 1a, 1b, 1c, to process said data and to make them available to the installations, in particular the present receptacle handling installation 1 to be evaluated for maintenance. By using information from multiple receptacle handling installations 1, 1a, 1b, 1c, the predictive maintenance of the receptacle handling installations 1, 1a, 1b, 1c may be improved by virtue of each individual installation benefiting from information from other comparable installations.

The maintenance support apparatus 400 in certain embodiments comprises an Internet/cloud application 410 that simplifies the obtainment and distribution of the information from the receptacle handling installations 1, 1a, 1b, 1c and in a manner standardized thereto and by using existing infrastructures and information protocols.

Furthermore, the maintenance support apparatus 400 may comprise data processing 420 in the form of a computer centre or of decentralized computing structures or may be in communication with such.

The data processing 420 may provide a central database, a server, AI applications, etc. Besides automatically queryable data, data may additionally be entered manually into a database of the data processing 420 as required, for example from laboratory tests.

Process data that may be measured in one or more of the receptacle handling installations 1, 1a, 1b, 1c and obtained by the maintenance support apparatus 400 comprise for example data of one or more of the following process parameters: bottling pressure, pressurization time, pressurization pressure, evacuation pressure, fill rate, fill curve, depressurization time, each individually detectable for the filling elements 22; tank pressure; treatment time (cleaning time, sterilization time, rinsing time) on the basis of various installation parts and on the basis of the treatment medium (cleaning agent, sterilizing agent, rinsing agent); temperature; temperature/time profile; conductivity; flow; information about deposits or residues.

The maintenance support apparatus 400 allows information from different sensor types, sensor positions, etc. to be combined and processed in this manner, even if the present receptacle handling installation 1 to be considered is not equipped with the sensors in question. The present receptacle handling installation 1 is therefore able to benefit from other installations having sensors and to learn from the sensor data thereof. In other words, the measuring techniques of different receptacle handling installations 1, 1a, 1b, 1c are synergistically combined, as a result of which an individual receptacle handling installation 1, 1a, 1b, 1c may require fewer sensors and therefore the mechanical engineering effort falls overall.

Furthermore, such combination allows properties of the sensors, such as for example sensor positions or sensor settings, to be optimized. By way of example, different sites of a sensor on two or more comparable receptacle handling installations 1, 1a, 1b, 1c may be compared with one another in order to find the optimum sites and/or settings.

Illustrative data processing for predictively maintaining the receptacle handling installation 1 may comprise: data transmission of one or more bottling rounds of all filling elements 22 to the Internet/cloud application 410 of the maintenance support apparatus 400; classification of a time series of a filling operation by the data processing 420, for example using statistical methods, neural networks or the like.

In the simplest case the classification distinguishes between a good filling operation and a poor filling operation (=binary classification). The maintenance support process therefore comprises creating a classified database, i.e. one or more filling operations are recorded, and each operation is assigned to a class, for example good filling operation/poor filling operation. In the present simple case of binary classification, the filling operations may therefore be sorted into the classes “good receptacle” and “poor receptacle” by evaluating relevant process parameters. Depending on the number of classes, it is also possible to distinguish between multiple filling element states.

Assigning the filling operations to specific fault classes then allows action recommendations to be derived. By way of example, a measure of the state of wear of each individual filling element 22 may be derived and reported back to the receptacle handling installation 1, an operator, a manufacturer of the receptacle handling installation 1, a maintenance centre, spare parts store or the like.

In a further development of the maintenance support process described above, the analysis of the recorded time series of a poor filling operation may comprise a look back at the time before the onset of a fault state. A further class “borderline case” may be derived therefrom. If such a borderline case is detected subsequently, a predictive measure may be performed on the filling element 22 in question even before a fault occurs. In line with the above terminology, this expansion stage contains the following classes: “good receptacle”, “poor receptacle”, “borderline cases”.

In a further development, further fault classes may be analysed and the database expanded to include these fault classes. By way of example, spare parts suggestions may thus be derived therefrom and returned to the receptacle handling installation 1, an operator, a manufacturer of the receptacle handling installation 1, a maintenance centre, spare parts store or the like. In line with the above terminology, this expansion stage contains the following classes: “good receptacle”, “poor receptacle, component A defective”, “poor receptacle, component B defective”, “borderline case component A running/defective”, “borderline case component B running/defective”, etc.

The maintenance support process described above relates to the filling process by way of illustration, but may be analogously transferred to processes of other receptacle handling stations of the receptacle handling installation(s) 1, 1a, 1b, 1c, for example to blow moulding and capping the receptacles 100.

The predictive maintenance apparatus 400 permits predictive, flexible and individual maintenance of the receptacle handling installation(s) 1, 1a, 1b, 1c, in particular of the filling elements 22, where present. An associated occurrence is simplification of spare parts procurement, for example by way of integration into an e-shop by linking to an existing customer account and/or automatic processing, in certain embodiments by applying so-called “smart contracts” and crypto currencies.

The described classification of the recorded handling processes may be extended to include new data at any time. The more fault classes there are in the analysis by the predictive maintenance apparatus 400, the more granular the way in which the classification is performed may be and the more accurately the modeling for determining states of wear and any prediction of defects, downtimes, etc., may take place.

The integration of an Internet/cloud application 410 into the predictive maintenance apparatus 400 allows the processes associated with predictive maintenance to be implemented as digital services.

If applicable, all individual features that are illustrated in the exemplary embodiments may be combined with one another and/or exchanged without departing from the scope of the invention.

What is claimed is:

1. A system comprising:
a first receptacle handling installation; and
a predictive maintenance apparatus in communication with an installation control of the first receptacle handling installation, wherein the predictive maintenance apparatus is configured to:
receive process data of a handling operation performed by the first receptacle handling installation on one or more receptacles,
assign the handling operation a quality class from a plurality of quality classes based on the process data, and
derive a state of wear for one or more components of the first receptacle handling installation from an analysis of the assigned quality class.

2. The system of claim 1, wherein one of the plurality of quality classes characterizes a first type of handling operation and another of the plurality of quality classes characterizes a second type of handling operation.

3. The system of claim 2, wherein the first type of handling operation comprises an acceptable handling operation and the second type of handling operation comprises an unacceptable handling operation.

4. The system of claim 3, wherein the predictive maintenance apparatus is further configured to analyze a past handling operation assigned a quality class characterized as unacceptable and to derive a further quality class from process data of the past handling operation, and the further quality class characterizes a limit-value handling operation.

5. The system of claim 1, wherein the predictive maintenance apparatus is further configured to:
receive process data of a handling operation performed by a second receptacle handling installation, and
assign the handling operation performed by the second receptacle handling installation to a quality class from the plurality of quality classes based on the received process data, or create a quality class from the received process data.

6. The system of claim 1, wherein the predictive maintenance apparatus is further configured to:
report the state of wear for the one or more components to the first receptacle handling installation; or
report an action recommendation derived from the state of wear for the one or more components to the first receptacle handling installation.

7. The system of claim 1, wherein the predictive maintenance apparatus comprises an Internet/cloud application or a data processing device.

8. The system of claim 7, wherein the data processing device comprises a database, a server, or an artificial intelligence (AI) application.

9. The system of claim 1, wherein:
the handling operation comprises a filling operation that places a filling product into a receptacle from the one or more receptacles, and
the process data comprises a process parameter.

10. The system of claim 9, wherein the process parameter comprises one or more of: a bottling pressure, a pressurization time, a pressurization pressure, an evacuation pressure, a fill rate, a fill curve, or a depressurization time.

11. The system of claim 1, wherein the first receptacle handling installation comprises a beverage bottling installation, and the beverage bottling installation comprises an apparatus configured to fill the one or more receptacles with a filling product.

12. The system of claim 11, wherein the apparatus comprises a filler control configured to control a filling operation, the filler control is in communication with the predictive maintenance apparatus, and the filler control is configured to send process data of the filling operation to the predictive maintenance apparatus.

13. The system of claim 12, wherein:
the apparatus further comprises a filler carousel and multiple filling elements installed on an outer circumference of the filler carousel,
the multiple filling elements are configured to introduce the filling product into the one or more receptacles, and
the predictive maintenance apparatus is configured to derive a state of wear for one or more of the multiple filling elements.

14. A method for predictively maintaining a first receptacle handling installation, comprising:
receiving process data of a handling operation performed by the first receptacle handling installation on one or more receptacles;
assigning the handling operation a quality class from a plurality of quality classes based on the process data; and
deriving a state of wear for one or more components of the first receptacle handling installation.

15. The method of claim 14, wherein one of the plurality of quality classes characterizes a first type of handling operation and another of the plurality of quality classes characterizes a second type of handling operation.

16. The method of claim 15, wherein the first type of handling operation comprises an acceptable handling operation and the second type of handling operation comprises an unacceptable handling operation.

17. The method of claim 16, further comprising analyzing a past handling operation assigned a quality class characterized as unacceptable and deriving a further quality class from process data of the past handling operation, wherein the further quality class characterizes a limit-value handling operation.

18. The method of claim 14, further comprising:
receiving process data of a handling operation performed by a second receptacle handling installation, and
assigning the handling operation performed by the second receptacle handling installation to a quality class from the plurality of quality classes based on the received process data, or creating a quality class from the received process data.

19. The method of claim 14, wherein:
the handling operation comprises a filling operation that places a filling product into a receptacle from the one or more receptacles, and
the process data comprises a process parameter.

20. The method of claim 19, wherein the process parameter comprises one or more of: a bottling pressure, a pressurization time, a pressurization pressure, an evacuation pressure, a fill rate, a fill curve, or a depressurization time.
